(19) United States
(12) Patent Application Publication
(10) Pub. No.: US 2012/0243044 A1
(43) Pub. Date: Sep. 27, 2012

(54) INFORMATION MANAGEMENT APPARATUS, INFORMATION MANAGEMENT METHOD AND RECORDING MEDIUM

(75) Inventors: Takashi Saitoh, Shizuoka-ken (JP); Yutaka Tamada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/426,916

(22) Filed: Mar. 22, 2012

Related U.S. Application Data
(60) Provisional application No. 61/467,630, filed on Mar. 25, 2011.

(51) Int. Cl. G06K 15/02

(52) U.S. Cl. 358/1.15

(57) ABSTRACT

A system which can provide information in which usage of a user of an image forming apparatus can be easily comprehended by the user who uses the image forming apparatus connected to a network is provided.

The information management system according to an embodiment include: an information collection section configured to collect completion process information indicating process content of an image forming process completed in an image forming apparatus to be managed, and to register, in a tabulation database, usage of every user of the image forming apparatus to be managed; an item information acquisition section configured to acquire item specification information; a basic information acquisition section configured to acquire, from the tabulation database, basic information; an information creation section configured to create the use information configured by information items specified in the item specification information; and an output section configured to output the use information to the outside.

### CROSS-REFERENCE TO RELATED APPLICATIONS

This application is based upon and claims the benefit of priority from U.S. provisional application 61/467,630, filed on Mar. 25, 2011; the entire contents of which are incorporated herein by reference.

### TECHNICAL FIELD

Embodiments described herein relate generally to a method configured to manage usage of an image processing apparatus connected to a network.

### BACKGROUND

Conventionally, an image processing apparatus such as an MFP (Multi Function Peripheral) is connected to a network such as an LAN (Local Area Network), and a user can output a print job to an arbitrary MFP within the network and can execute printing in the arbitrary MFP.

Moreover, when the user uses the MFP in a network environment in which a plurality of MFPs are connected, a process recognizing use of the MFP on the network is performed by a log-in process using a user ID allocated to each user.

By performing a log-in process when using the MFP, not only can the use of the MFP be permitted to only a user having a use right, but also usage can be managed for each user ID.

For example, by storing the number of printed sheets for each user ID, the monthly number of printed sheets can be comprehended, the number of sheets printed can be limited by providing an upper limit to the number of sheets that can be printed, whereby waste prints can be prevented from being performed.

However, this collected information merely performs a counting process, and information desired by the user cannot be easily confirmed.

### DESCRIPTION OF THE DRAWINGS

FIG. 1 is a system block diagram showing a system according to an embodiment.

FIG. 2 is a block diagram showing a configuration of the use information management apparatus shown in FIG. 1.

FIG. 3 is a block diagram showing a configuration of the image forming apparatus and client terminal shown in FIG. 1.

FIG. 4 is a block diagram showing a configuration of a print server and a completed job information collection apparatus.

FIG. 5 is a functional block diagram showing a function of the completed job information collection apparatus of this embodiment.

FIG. 6 shows an example data structure of a tabulation database provided to the completed job information collection apparatus.

FIG. 7 is a functional block diagram showing a function of the use information management apparatus.

FIG. 8 shows an example data structure of a use information database.

FIG. 9 is an example screen displayed on a touch panel of the image forming apparatus, when the user requests a display of the use information in the image forming apparatus.

FIG. 10 is a flow chart showing the flow of a provision process of the use information.

FIG. 11 is another example screen displayed on the touch panel of the image forming apparatus, when the user requests a display of the use information in the image forming apparatus.

FIG. 12 is another example screen displayed on the touch panel of the image forming apparatus, when the user requests a display of the use information in the image forming apparatus.

FIG. 13 is a functional block diagram of the use information management apparatus in another embodiment.

### DETAILED DESCRIPTION

According to the embodiments, an information management system includes an information collection section, an item information acquisition section, a basic information acquisition section, an information creation section, and an output section. The information collection section collects completion process information that shows process content of a completed image forming process in the image forming apparatus to be managed, and registers usage information of each user of this image forming apparatus to be managed in a tabulation database, on the basis of the collected completion process information. The item information acquisition section acquires item specification information that specifies information items, serving as types of information of at least one of registration information registered in the tabulation database and information capable of calculation by using the registration information. The basic information acquisition section acquires, from the tabulation database, basic information necessary for creating use information configured by information items specified in the item specification information. The information creation section creates, from the basic information acquired by the basic information acquisition section, the use information configured by information items specified in the item specification information. The output section outputs, to the outside, the use information created by the information creation section.

Hereinafter, embodiments will be described with reference to the drawings.

### First Embodiment

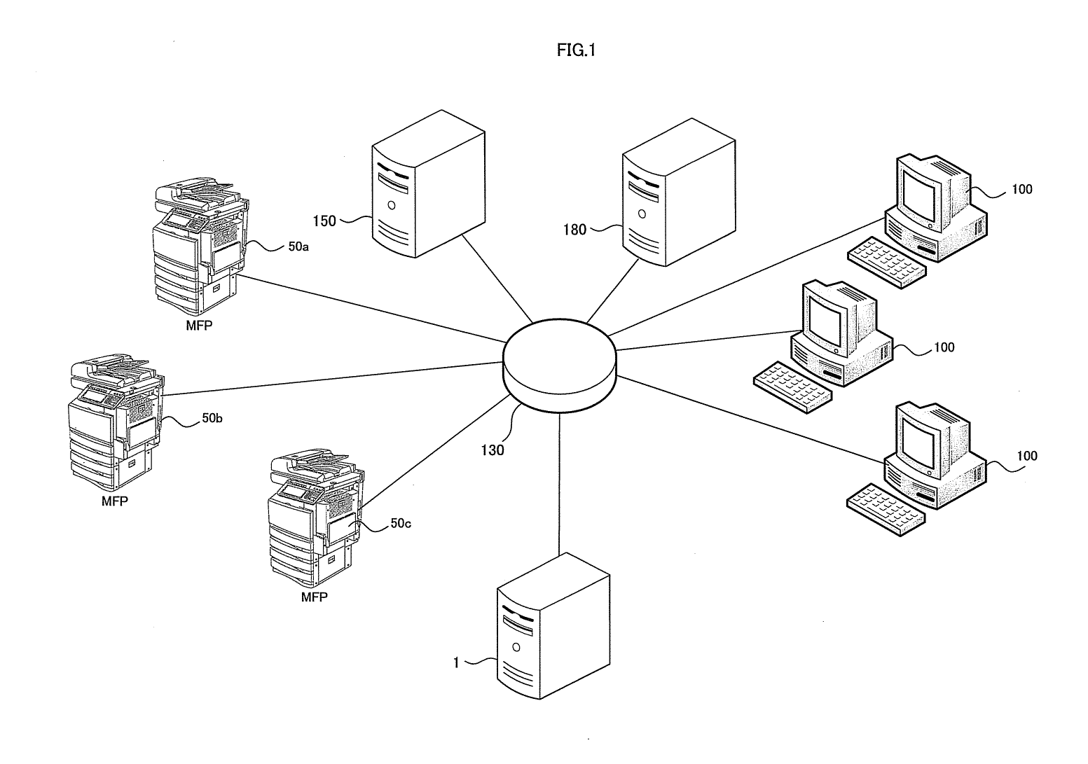

FIG. 1 is a system block diagram showing a system according to this embodiment. The information management system of this embodiment includes a use information management apparatus 1, an image forming apparatus 50 (shown as 50a to 50c in FIG. 1), a client terminal 100, a print server 150, and a completed job information collection apparatus 180 as an information collection section. These apparatuses are connected via a network 130.

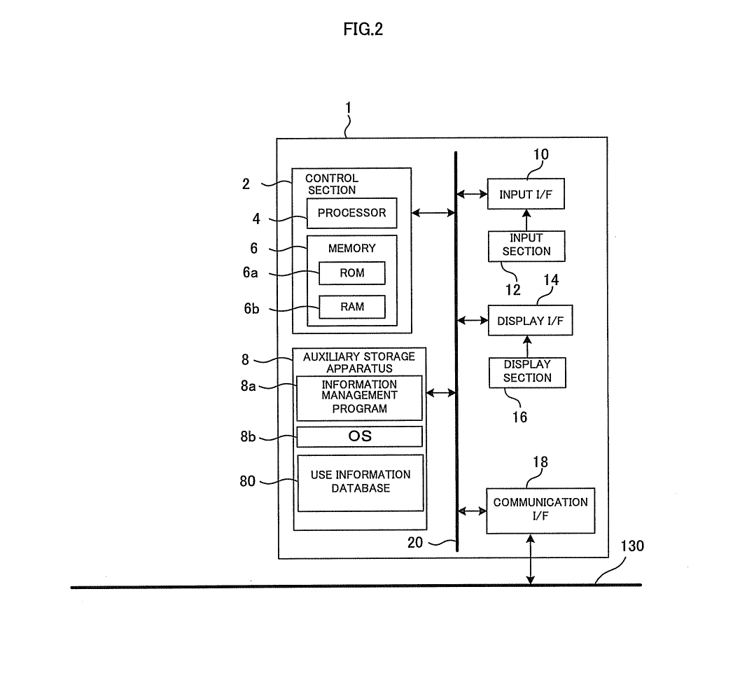

Firstly, the configuration of the use information management apparatus 1 is described. FIG. 2 is a block diagram showing a configuration of the use information management apparatus 1 shown in FIG. 1. The use information management apparatus 1 creates use information relating to usage of the image forming apparatus 50, for a user using the image forming apparatus connected within the network 130, and provides created use information depending on a request from the image forming apparatus 50 and the client terminal 100.

The use information management apparatus 1 is a computer, and includes a control section 2, an auxiliary storage apparatus 8, an input interface (input I/F) 10, an input section 12, a display interface (display I/F) 14, a display section 16, and a communication interface (communication I/F) 18. Each component of the use information management apparatus 1 is connected via a bus 20.

The control section 2 functions by a processor 4 composed of a CPU (Central Processing Unit) or an MPU (Micro Processing Unit), a memory 6 and an OS (Operating System) 8b.

The processor 4 executes an information management program 8a stored in the auxiliary storage apparatus 8, and executes a process managing the use information. Moreover, the processor 4 additionally executes a control program (for example, firmware such as BIOS) stored in the memory 6 and the OS 8b stored in the auxiliary storage apparatus 8, and controls the use information management apparatus 1.

The memory 6 is, for example, a semiconductor memory, and has a ROM (Read Only Memory) 6a storing a control program of the processor 4, and a RAM (Random Access Memory) 6b providing a temporary work area in the processor 4.

The control section 2 may contain an ASIC (Application Specific Integrated Circuit) implementing part or all of the functions which are provided in the use information management apparatus 1. For example, part or all of the functions according to this embodiment, which are implemented by the processor 4 executing the information managing program 8a, may be implemented by the ASIC.

The auxiliary storage apparatus 8 stores the information management program 8a, which controls the process managing the use information, the OS 8b, which is a program managing the whole system of the use information management apparatus 1, and a use information database 80. A data structure of the use information database is described later.

The auxiliary storage apparatus 8 may be, for example, a hard disk drive or another magnetic storage apparatus, an optical storage apparatus, a semiconductor storage apparatus such as a flash memory, or an arbitrary combination of these.

The input I/F 10 is an interface connecting the input section 12. The input section 12 is an input device such as a keyboard, a pointing device like a mouse, or a touch panel, and may include any or a plurality of types.

The display I/F 14 is an interface connecting the display section 16. The display I/F 14 receives data to be displayed on the display section 16, from another component connected to the bus 20, and outputs the display data to the display section 16.

The display section 16 displays the output display data and is, for example, a display attached to a PC or a touch panel.

Since the use information management apparatus 1 is not a PC in which a user normally performs various processes, it does not have to include an input section 12 serving as an input device, a display I/F 14, and a display section 16.

The communication I/F 18 is an interface connecting to external devices. The communication I/F 18 communicates with, for example, external devices (such as the image forming apparatus 50, the client terminal 100, the print server 150, the completed job information collection apparatus 180 and USB devices) via the network 130 by appropriate wireless communication such as Bluetooth (registered trademark), an infrared connection, an optical connection and the like in accordance with IEEE802.15, IEEE802.11, IEEE802.3, IEEE1284 and the like, or appropriate wired communication such as a USB. The control section 2 communicates with an external device such as the image forming apparatus 50 via the communication I/F 18. In this embodiment, as described below, the control section 2 creates necessary information by acquiring, via the communication I/F 18, information relating to the usage, and provides the created information to the outside, via the communication I/F 18.

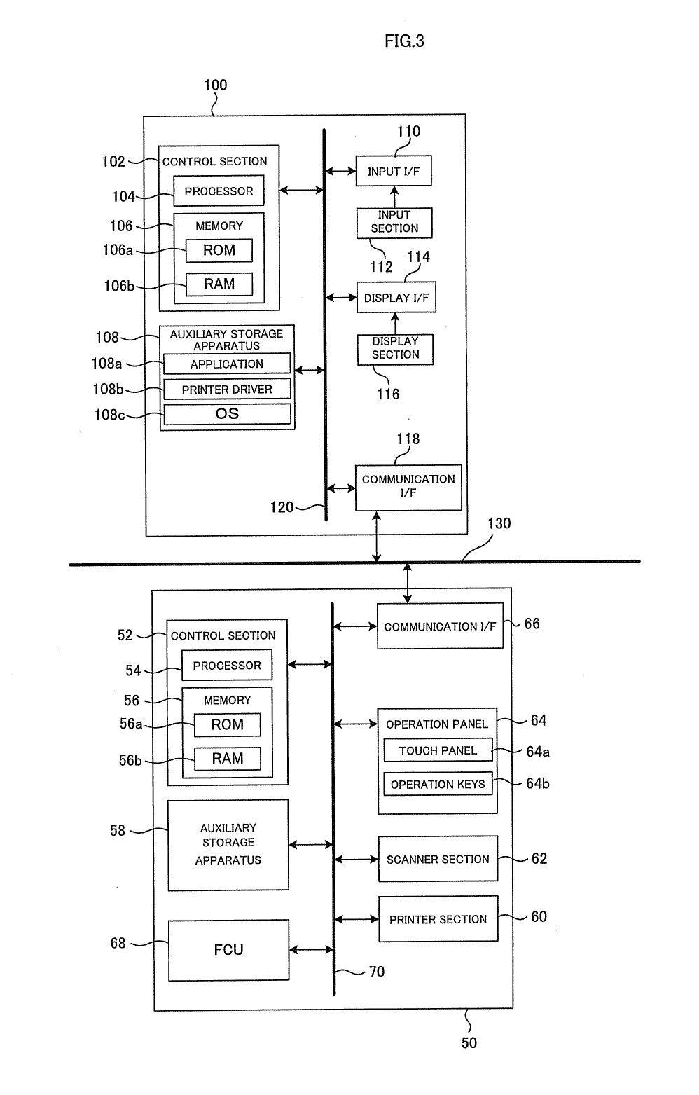

A configuration of the image forming apparatus 50 connected to the network 130 is now described. FIG. 3 is a block diagram showing a configuration of the image forming apparatus 50 and the client terminal 100 shown in FIG. 1.

Firstly, the image forming apparatus 50 is an MFP (Multi Function Peripheral), which includes a plurality of functions such as copy, scan and fax. The image forming apparatus 50 includes a control section 52, an auxiliary storage apparatus 58, a printer section 60, a scan section 62, an operation panel 64, a communication interface (communication I/F) 66, and a facsimile control unit (FCU) 68. Each component of the image forming apparatus 1 is connected via a bus 70.

The control section 52 functions by an OS stored in the processor 54, memory 56 and auxiliary storage apparatus 58.

The processor 54 is a CPU or an MPU.

The memory 56 is, for example, a semiconductor memory. The memory 56 includes a ROM 56a storing a control program of the processor 54, and a RAM 56b providing a temporary work area in the processor 54.

The control section 52 controls the printer section 60, the scan section 62, the operation panel 64, the communication I/F 66 and the FCU 68, on the basis of the control program stored in the ROM 56a or the auxiliary storage apparatus 58. The control section 52 may further have a variety of image processing functions. Also, the control section 52 may include an ASIC implementing part or all of the functions which are provided in the image processing apparatus 50.

The auxiliary storage apparatus 58 stores an application program and the OS. The application program contains a program executing a function which the image processing apparatus 50 has, such as a copy function, a print function, a scan function, a facsimile function or a network file function. The application program further includes applications for a web client (web browser) and other applications.

The auxiliary storage apparatus 58 stores image data generated by reading a manuscript with the scan section 62, and data or the like acquired from external devices connected to the communication I/F 66. Moreover, the auxiliary storage apparatus 58 temporary keeps, until executing, a job which is a process unit when an image forming process is performed on a sheet of paper or the like, in the image forming apparatus 50. The jobs include a print job indicating printing output from the client terminal, a copy job indicating a copy process, and a facsimile job indicating printing of an image received by a facsimile.

When describing simply a “job” in the description of this embodiment, a job performing an image forming process on a sheet, in the printer section 60 of the image forming apparatus 50, is shown. More specifically, a job is any of the above-mentioned print job, copy job and facsimile job.

The auxiliary storage apparatus 58 may be, for example, a magnetic storage apparatus such as a hard disk drive, an optical memory, a semiconductor storage apparatus (flash memory, etc.), or an arbitrary combination of these. The auxiliary storage apparatus 58 appropriately keeps software updates, protected electronic documents, text data, account information, policy information or the like.

The printer section 60 forms on the sheet, for example, an image obtained by reading a manuscript with the scanner section 62, and an image contained in a print job which has been sent, via the network 130, from a computer such as the external client terminal 100. The printer 60 is composed of, for example, a process unit, a transfer unit for transferring a toner image to a sheet of paper, and a fixing apparatus.

The scanner section 62 includes a scanning-reading unit, a manuscript-mounting platform, and an automatic manuscript sending apparatus, which conveys a manuscript to a reading position. The scanning-reading unit reads a manuscript set on the manuscript-mounting platform or the automatic manuscript sending apparatus.

The operation panel 64 includes a touch panel 64a and various operation keys 64b. The touch panel 64a displays, for example, the size of a sheet of paper, the number of copied sheets, a print density setting, an Nin1 setting or a setting content relating to a print condition for finishing such as binding and folding. The operation keys 64b are, for example, a numeric keypad, a reset key, a stop key and a start key. The user can perform, for example, an operation input indicating execution of various processes, and an operation input, which sets and modifies the print condition, by the touch panel 64a or the operation keys 64b. The screen display is not limited to a touch panel 64a and may be a normal liquid crystal screen which is not a touch panel. In this case, a print condition setting operation may be performed by operating the operation keys 64b.

The communication I/F 66 is an interface that connects, via the network 130, to external devices such as the client terminal 100 and the use information management apparatus 1, and to the image forming apparatus 50. External devices such as a flash memory may be directly connected to the communication I/F 66.

The communication I/F 66 connects, for example, to external devices by appropriate wireless communication such as Bluetooth (registered trademark), an infrared connection, an optical connection and the like in accordance with IEEE802.15, IEEE802.11, IEEE802.3, IEEE1284 and the like, or appropriate wired communication such as a USB. The communication I/F 66 contains a buffer, and temporally holds, in the buffer, part or all of the data received via the network 130.

The control section 52 communicates with external devices such as the client terminal 100 and the use information management apparatus 1, via the communication I/F 66 and the network 130.

The facsimile control unit (FCU) 68 controls a transmitting process and a receiving process of a facsimile in the image forming apparatus 50.

The client terminal 100 includes a control section 102, an auxiliary storage apparatus 108, an input interface (input I/F) 110, an input section 112, a display interface (display I/F) 114, a display section 116, and a communication interface (communication I/F) 118. Each component of the client terminal 100 is connected via a bus 120. A PC (Personal Computer), portable terminal or a tablet-type terminal may be used as the client terminal 100.

The control section 102 functions by a processor 104 composed of a CPU or an MPU, a memory 106 and an OS 108c.

The processor 104 executes an application 108a stored in the auxiliary storage apparatus 108 (or memory 106), and performs various processes. Moreover, the processor 104 starts the printer driver 108b, generates a print job from data to be printed, and executes a process transmitting this print job to the image forming apparatus 50, via the communication I/F 118 and the network 130.

The memory 106 is, for example, a semiconductor memory, and has a ROM 106a storing a control program of the processor 104, and a RAM 106b providing a temporary work area in the processor 104.

The auxiliary storage apparatus 108 stores the application program 108a, the printer driver 108b, and the OS 108c, which is a control program of the processor 104.

The application program 108a operates in a state where software corresponding to the OS 108c and the OS 108c itself are executed. The application program 108 may contain, in addition to general software such as document creating software, a web application.

The printer driver 108b is a device driver that performs instructions of printing to the image forming apparatus 1, on the basis of print instructions from the application program 108, and works as software of the OS 108c.

The auxiliary storage apparatus 108 having the above-mentioned functions may be, for example, a hard disk drive or another magnetic storage apparatus, an optical storage apparatus, a semiconductor storage apparatus such as a flash memory, or an arbitrary combination of these.

The input I/F 110 is an interface connecting an input section 112. The input section 112 is an input device such as a pointing device like a mouse, keyboard or a touch panel, and may include any or a plurality of types.

The display I/F 114 is an interface connecting the display section 116. The display I/F 114 receives data to be displayed on the display section 116, from other components connected to the bus 120. The display I/F 114 outputs display data to the display section 116, and the display section 116 displays the display data. The display section 116 is, for example, a display attached to a PC or a touch panel.

The communication I/F 118 is an interface connecting to external devices. The communication I/F 18 is connected to, for example, external devices (for example, the use information management apparatus 1 and the image forming apparatus 50) via the network 130 by appropriate wireless communication such as Bluetooth (registered trademark), an infrared connection, an optical connection and the like in accordance with IEEE802.15, IEEE802.11, IEEE802.3, IEEE1284 and the like, or appropriate wired communication such as a USB. The control section 102 communicates with external devices other than the use information management apparatus 1, the image forming apparatus 50 and a USB device, via the communication I/F 118.

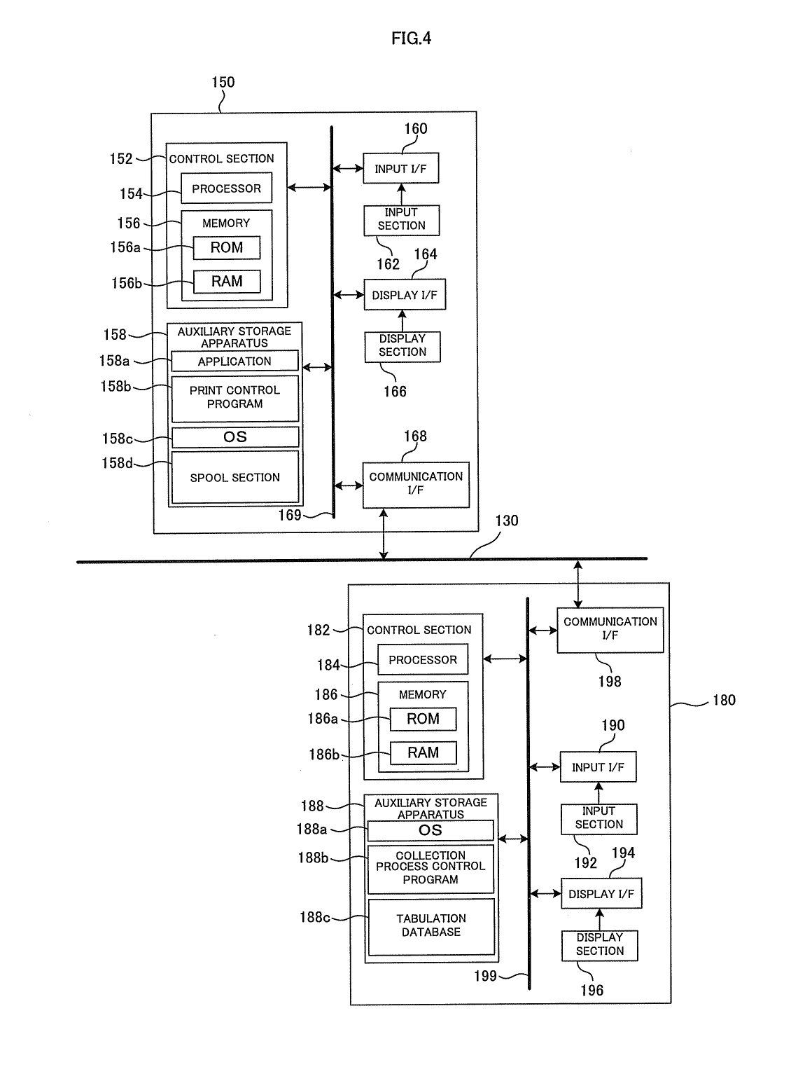

A configuration of the print server 150 and the completed job information collection apparatus 180 is now described. FIG. 4 is a block diagram showing a configuration of the print server 150 and the completed job information collection apparatus 180.

Firstly, the print server 150 is a server that executes an image forming process for the image forming apparatus 50, on the basis of the print job acquired from the client terminal 100. The print server 150, as shown in FIG. 4, may basically be a configuration similar to the client terminal 100. In the following description, descriptions of parts that overlap with the descriptions of the client terminal 100 are omitted.

The control section 152 includes the client terminal 100 as well as a processor 154 and a memory 156. The control section 152 controls the print server 150 by causing the processor 154 to execute a program stored in a memory 156 or an auxiliary storage apparatus 158, and executes various processes. Moreover, the control section 152 temporarily stores in the auxiliary storage apparatus 158 a print job acquired from the client terminal 100, and outputs the print job to a specified image forming apparatus 50 to cause the image forming apparatus 50 to perform an image forming process. The control section 152 also outputs, in response to the operation input of a user in the image forming apparatus 50, a specified print job to a specified image forming apparatus 50 to cause the image forming apparatus 50 to perform an image forming process.

The auxiliary storage apparatus 158 stores various application programs 158a, a print control program 158b for performing an image forming process in the image forming apparatus 50, and an OS 158c. Moreover, a spool section 158d, where the print job is temporarily kept, is contained in the auxiliary storage apparatus 158.

Since the input I/F 160, the input section 162, the display I/F 164 and the display section 166 are similar to the client terminal 100, their description will be omitted. When the print server 150 is configured by dedicated hardware instead of a PC, it may not necessarily include the input section 162 serving as an input device, or the display section 166.

The communication I/F 158 is also basically similar to the communication I/F 118 of the client terminal 100, and is an interface for allowing the print server 150 to perform communication with external devices connected to the network 130, such as the image forming apparatus 50 and the client terminal 100, by wireless and wired communications.

The completed job information collection apparatus 180 is an apparatus that collects, from the image forming apparatus 50, jobs which are completed for use when used by the image forming apparatus 50 (image forming apparatuses 50a to 50c in FIG. 1) connected with the network 130, and creates a database of the content of the collected jobs. The completed job information collection apparatus 180 may be configured with a personal computer or a dedicated computer.

The completed job information collection apparatus 180 includes a control section 182, an auxiliary storage apparatus 188, and a communication interface (communication I/F) 198. Each component of the completed job information collection apparatus 180 is connected via a bus 199.

The control section 182 functions by a processor 184 composed of a CPU or an MPU, a memory 186, and an OS 188a.

The processor 184 executes a collection process control program stored in the auxiliary storage apparatus 188, and executes a process collecting use information. Moreover, the processor 184 additionally executes a control program (for example, firmware such as BIOS) stored in the memory 186 and the OS 188a stored in the auxiliary storage apparatus 188, and controls the completed job information collection apparatus 180.

The memory 186 is, for example, a semiconductor memory, and has a ROM 186a storing a control program of the processor 184, and a RAM 186b providing a temporary work area in the processor 184.

The control section 182 may contain an ASIC implementing part or all of the functions provided in the completed job information collection apparatus 180.

The auxiliary storage apparatus 188 stores the OS 188a, which is a program managing the whole system of the completed job information collection apparatus 180, and a collection processing control program 118b relating to a process collecting completed job information. In addition, the auxiliary storage apparatus 188 stores a tabulation database 188c. The function implemented by the processor 184 executing the collection processing control program 188b is further described in the description of the functional blocks. Moreover, the data structure of the tabulation database 188c is also described below.

The auxiliary storage apparatus 108 may be, for example, a hard disk drive or another magnetic storage apparatus, an optical storage apparatus, a semiconductor storage apparatus such as a flash memory, or an arbitrary combination of these.

The communication I/F 198 is an interface connecting to external devices. The communication I/F 198 is connected with, for example, external devices (such as the image forming apparatus 50, client terminal 100 and print server 150) via the network 130 by appropriate wireless communication such as Bluetooth (registered trademark), an infrared connection, an optical connection and the like in accordance with IEEE802.15, IEEE802.11, IEEE802.3, IEEE1284 and the like, or appropriate wired communication such as a USB. The control section 182 communicates with an external device such as the image forming apparatus 50, via the communication I/F 198. In this embodiment, the control section 182 collects the following job information, which is information of a print job completed in the image forming apparatus 50 (50a to 50c) connected to the network 130, via the communication I/F 198.

The completed job information collection apparatus 180 may additionally include an input I/F 190, an input section 192, a display I/F 194, and a display section 196. These are devices similar to those provided in the above-mentioned client terminal 50, and their description is omitted. The completed job information collection apparatus 180 may not necessarily include an input section 192 and a display section 196, when configured by a dedicated computer instead of a personal computer.

The above are configurations of each apparatus configuring an information management system of this embodiment. While the network 130, where each apparatus is connected, may be a network as long as each apparatus can mutually communicate, it may be configured by a LAN (Local Area Network), WAN (Wide Area Network) or the Internet. A processing method presenting usage of the image forming apparatus 50 in a system of this embodiment is now described.

A presenting process of usage in this embodiment includes causing the completed job information collection apparatus 180 to collect job information showing contents of a job completed in the image forming apparatus 50 connected to the network 130, and to create a database.

Also, the use information management apparatus 1 acquires basic information serving as required information, from the database of the completed job information collection apparatus 180, creates use information showing the usage by performing a required process for the acquired information, and provides this information on demand to the image forming apparatus 50 and the client terminal 100.

Here, the “job information”, collected by the completed job information collection apparatus 180 is information that can specify the contents of a job completed in the image forming apparatus 50, and in particular, means information showing the usage of the image forming apparatus 50 such as the number of printed sides and the number of printed sheets.

Specifically, the completed job is information containing at least information that can specify a value of each item registered in the below-described tabulation database 188c. Therefore, the “job information” may be a job itself, and may be information in which only information that can specify information registered in the database excluding the image data to be printed is included.

Among the functions for implementing the above series of processes, firstly, the function of the completed job information collection apparatus 180 is described.

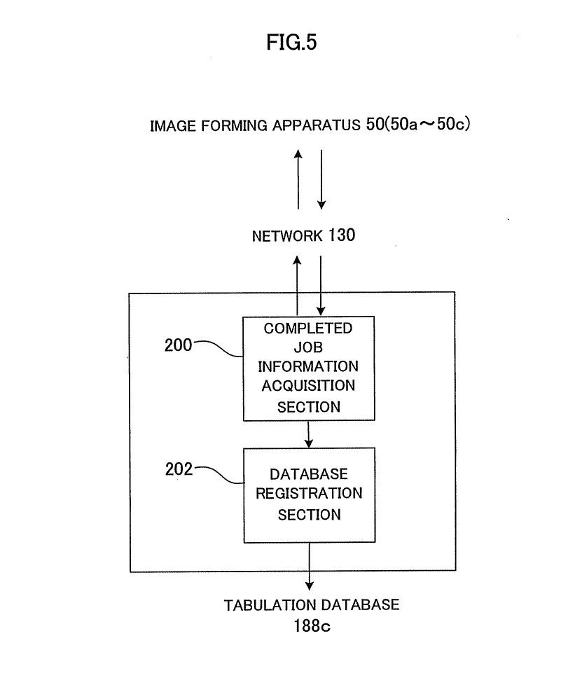

FIG. 5 is a functional block diagram showing a function of the completed job information collection apparatus 180 of this embodiment. The completed job information collection apparatus 180 includes a completed job information acquisition section 200, and a database registration section 202.

The completed job information acquisition section 200 requests and acquires job information of a job completed for the image forming apparatus 50. The completed job information acquisition section 200 requests job information for the image forming apparatus 50 (50a to 50c) regularly connected (for example, hourly or daily) to the network 130. In response to this request, the image forming apparatus 50 outputs the job information of a completed job to the completed job collection information apparatus 180, and the completed job information acquisition section 200 acquires the job information.

The database registration section 202 registers necessary information in the tabulation database 188c, on the basis of the job information acquired by the completed job information acquisition section 200.

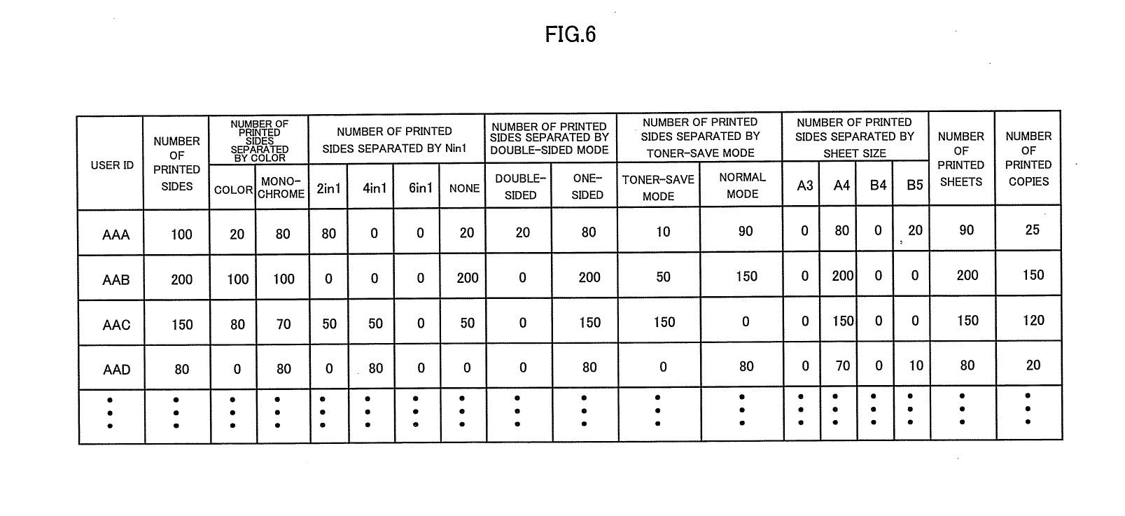

Here, FIG. 6 shows an example data structure of the tabulation database 188c which is provided in the completed job information collection apparatus 180. In the tabulation database 188c of this embodiment, each item of: (1) the number of printed sides (the number of printed sides; when double-sided printing, the number of printed sides are two surfaces for one sheet of paper), (2) the number of printed sheets, (3) the number of printed sides separated by color mode (number of printed sides by each of a color and monochrome mode), (4) the number of printed sides separated by Nin1 (number of printed sides by setting Nin1 as 2 in1 or 4in1), (5) the number of printed sides separated by a double-sided mode (number of printed sides by each of a double-sided mode and a single-sided mode), (6) the number of printed copies, (7) the number of toner-save printed sides (number of printed sides by a toner-save mode), and (8) the number of printed sides separated by sheet size (number of printed sides of each sheet size), is recorded by each user as a monthly cumulative value.

For example, a user having a user ID AAA prints 100 sides by this monthly printed surface number, of which 20 sides are color prints and the remainder monochrome prints. Moreover, 80 of these 100 sides are printed as 2 in1, and 20 sides are printed without a Nin1 setting. Moreover, since 20 sides are printed as double-sided printing and 80 surfaces are printed as single-sided printing, the number of printed sheets becomes 90 sheets.

The database registration section 202 extracts or calculates values corresponding to each item of the tabulation database 188c on the basis of job information, and registers the values in the tabulation database 188c.

Since the usage of each user is managed as a monthly cumulative value by the tabulation database 188c of this embodiment, the monthly data is kept for each user. Only the monthly cumulative value at this time is shown by the data table of FIG. 6, and the data of the monthly usage is stored, for every user, by the tabulation database 188c.

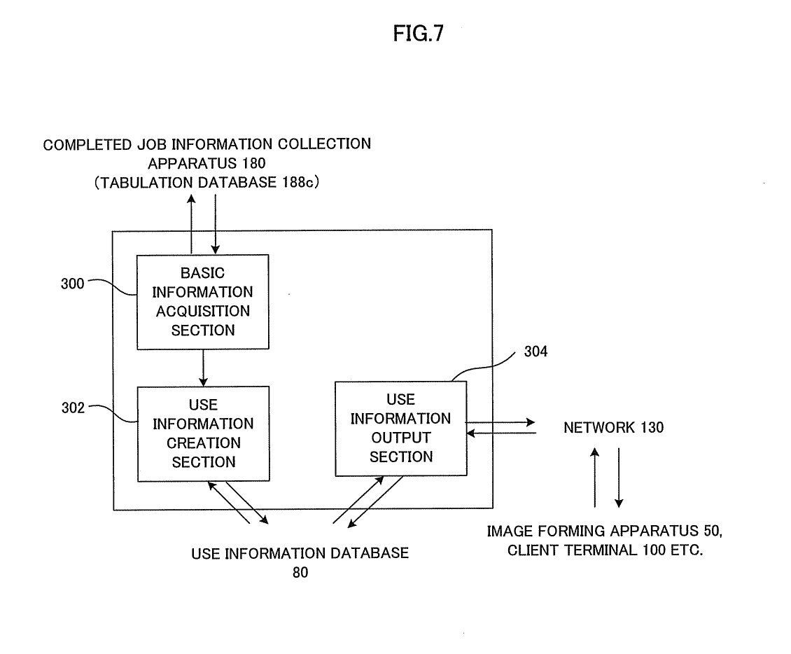

A function of the use information management apparatus 1 is now described. FIG. 7 is a functional block diagram showing a function of the use information management apparatus 1. The use information management apparatus 1 includes a basic information acquisition section 300, a use information creation section 302, and a use information output section 304.

The basic information acquisition section 300 acquires, from the tabulation database 188c of the completed job information collection apparatus 180, basic information necessary for creating the use information provided by the use information management apparatus 1.

The basic information is information provided by the use information management apparatus 1 when receiving a request from the image forming apparatus 50, and required for creating the use information indicating usage of the image forming apparatus 50 (50a to 50c) of respective users connected to the network 130. Job information of the completed job is collected, by the above-described completed job information collection apparatus 180, and information relating to the usage of the image forming apparatus 50 within the network 130 is comprehensively collected in the tabulation database 188c. On the other hand, since the use information provided by the above-described use information management apparatus 1 presents information of each item specified by a manager and a user of the system, only the information of each specified item, among information that the tabulation database 188c keeps, is required.

Therefore, the basic information acquisition section 300 acquires by extracting information of the items necessary for creating the use information from information collected in the tabulation database 188c. When the use information management apparatus 1 provides monthly use information, information of the provided month is acquired.

The items of information provided as use information are information collected in the tabulation database 188c itself or combined collected information, or are information items that can be calculated by performing a prescribed operation process. For example, if the rate of double-sided printing is required for calculating a fee when the user wants to calculate a monthly usage fee, the rate of double-sided printing can be specified as an item of the use information. As a result, since the rate of double-sided printing is included in the use information, calculation will becomes easier when calculating a usage fee by consulting to the use information.

The use information creation section 302 creates use information which is provided by the use information management apparatus 1, by using basic information acquired by the basic information acquisition section 300. Also, the use information creation section 302 registers the created use information in the use information database 80.

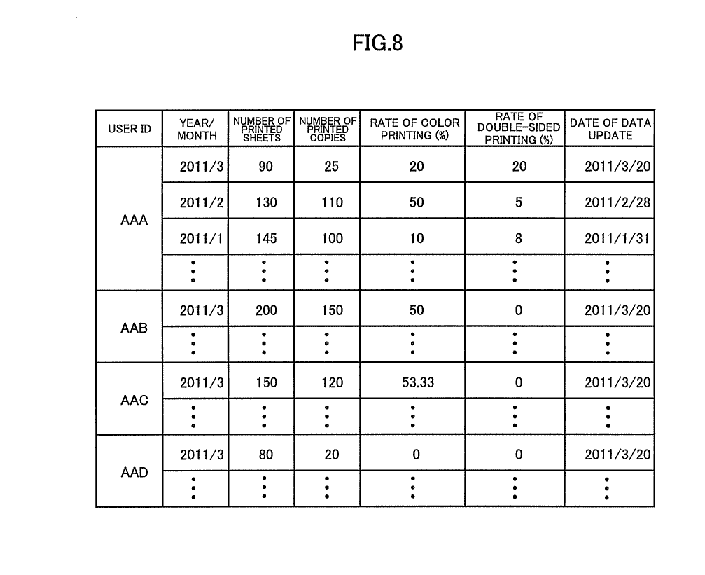

Here, FIG. 8 shows an example data structure of the use information database 80. The use information database 80 of this embodiment registers the number of printed sheets, the number of printed copies, the rate of color printing, the rate of double-sided printing, and the date of data update, and information including items used as the use information is provided to an external device such as the image forming apparatus 50. Information of the number of printed sheets and the number of printed copies is information registered by the same items in the tabulation database 188c. The rate of color printing is a value in which the number of printed color sides registered in the tabulation database 188c is divided by the (total) number of printed sides, and specifically, is obtained by:

(the number of printed color sides/the number of printed sides×100) (%).

The rate of double-sided printing is a value in which the number of double-sided printed sides registered in the tabulation database 188c is divided by the (total) number of printed sides, and specifically, is:

(the number of double-sided printed sides/the number of printed sides×100) (%).

The date of data update is the date when the data was updated, by the use information creation section 30 registering the information in the use information database 80.

Therefore, in order to construct the use information database 80 of the data structure shown in FIG. 8, the basic information acquisition section 300 of this embodiment is required to acquire, from the tabulation database 188c, information of the number of printed sheets, the number of printed copies, the number of printed sides, the number of printed sides by color, and the number of printed sides by double-sided printing. Also, the use information creation section 302 uses this acquired information, and registers information of each item in the use information database 80 by the above-mentioned calculation.

This use information database 80 is regularly updated. Specifically, the basic information acquisition section 300 may acquire, regularly from the tabulation database 188c at a preset period, information necessary for creating the use information, and the use information creation section 302 may create the use information and update information of the use information database 80. The date when this update is performed is recorded as the date of data update in the use information database 80.

The basic information acquisition section 300 acquires, among necessary basic information, only basic information corresponding to information modified in the tabulation database 188c. The use information creation section 302 may create only use information corresponding to information that has been modified and, regardless of any modification in the tabulation database 188c, may entirely acquire, each time, basic information necessary for creating the use information, and create the use information.

Moreover, while the items of information registered in the use information database 80 are described in FIG. 8 as common to all users, they are not limited to this. For example, the items managed/provided as use information for each user can be arbitrary specified. When specifying items of the use information for each user, for example, the use information management apparatus 1 may display a setting screen, where an operation input specifying items from a user is received, and may further include a function of the item information acquisition section, which acquires item specification information generated by the operation input to the screen. Also, the basic information acquisition section 300 may acquire, from the tabulation database 188c, basic information necessary for creating use information corresponding to the specified items, on the basis of this item specification information.

The use information output section 304 extracts, when a user performs an operation requesting to display their own use information in the image forming apparatus 50 or the client terminal 100, use information of this user from the use information database 80, and transmits this information as use information to the image forming apparatus 50 or the client terminal. In this case, a user ID identifying a requested user is included in the request of the use information, and the use information output section 304 acquires use information associated with this user ID from the use information database 80. The image forming apparatus 50 or the client terminal 100 acquires the transmitted use information, and displays the acquired use information on a screen (touch panel 64a if the image forming apparatus 50, and display section 116 if the client terminal 100).

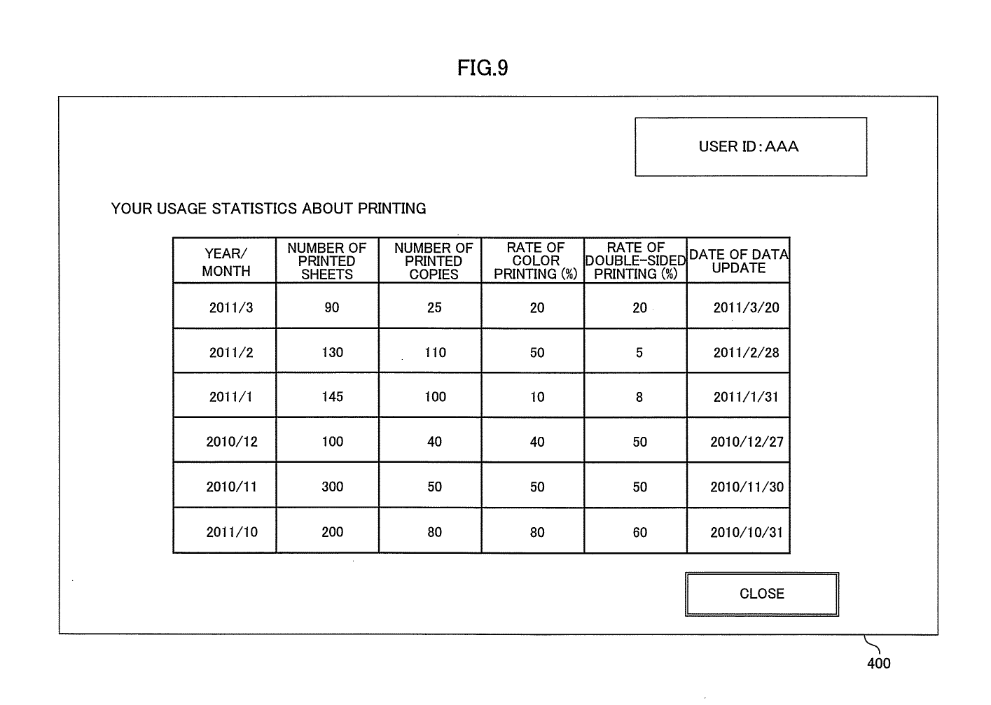

Here, FIG. 9 shows a screen 400 displayed on the touch panel 64a of the image forming apparatus 50 when a user, having a user ID AAA in the image forming apparatus 50, requests a display of the use information, in the image forming apparatus 50, by an input operation to the touch panel 64a and the like.

Thus, the use information management apparatus 1 of this embodiment and the system of this embodiment can create information of items desired by the user for the usage of the network 130 in accordance with a request of the user, and can provide information to the user.

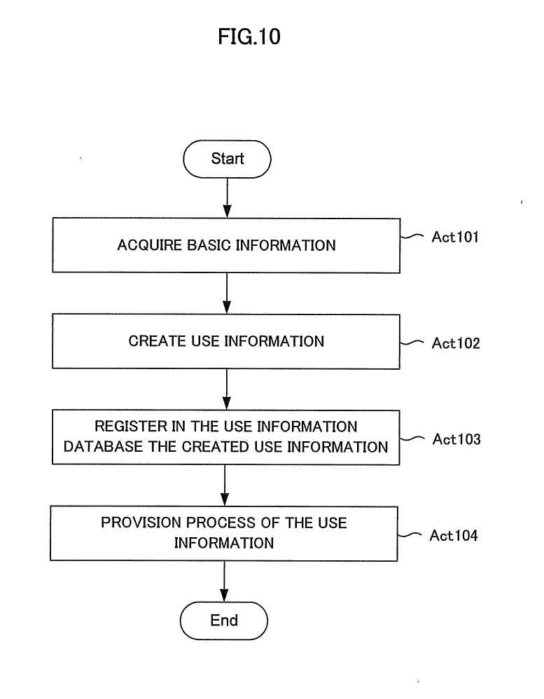

A flow of a provision process of the use information of this embodiment is now described. FIG. 10 is a flow chart that shows the flow of a provision process of the use information.

Firstly, the basic information acquisition section 300 acquires, from the tabulation database 188c of the completed job information collection apparatus 180, basic information for creating information of each item provided as use information (Act 101). The use information management apparatus 1 acquires or keeps item specification information that specifies items provided beforehand as the use information, and the basic information acquisition section 300 acquires basic information, on the basis of this item specification information.

The use information creation section 302 uses basic information acquired by the basic information acquisition section 300 in Act101, and creates information of each item provided as use information (Act102).

The use information creation section 302 registers the created use information in the use information database 80 (Act103).

When a user operates the image forming apparatus 50 or the client terminal to display their own use information, the use information output section 304 receives the input operation, and outputs the use information associated with the user ID of this user to the apparatus with the request (Act104).

The above is a flow of a process in which the use information management apparatus 1 of this embodiment provides the use information. Act101 to Act103 are processes registering a creation process of the use information and this use information in the use information database 80, and Act104 is a process providing the use information using the information registered in the use information database 80.

Therefore, it is not necessary for Act103 to Act104 to be performed in series. The process of Act104 is not limited to the timing after that of Act 103, and may be performed when there is a provided request of the use information.

In this embodiment, while the completed job information acquisition section 200 of the completed job information collection apparatus 180 is described as being acquired by requesting job information in the image forming apparatus 50, the embodiment is not limited to this. The image forming apparatus 50 may transmit, when a job is completed, job information of a completed job to the completed job information collection apparatus 180 at the completion of the job or regularly. In this case, the image forming apparatus 50 (50a to 50c) may include a function of the job information transmitting section, which transmits the job information. The job information transmitting section may be implemented by the processor 54, which executes a program.

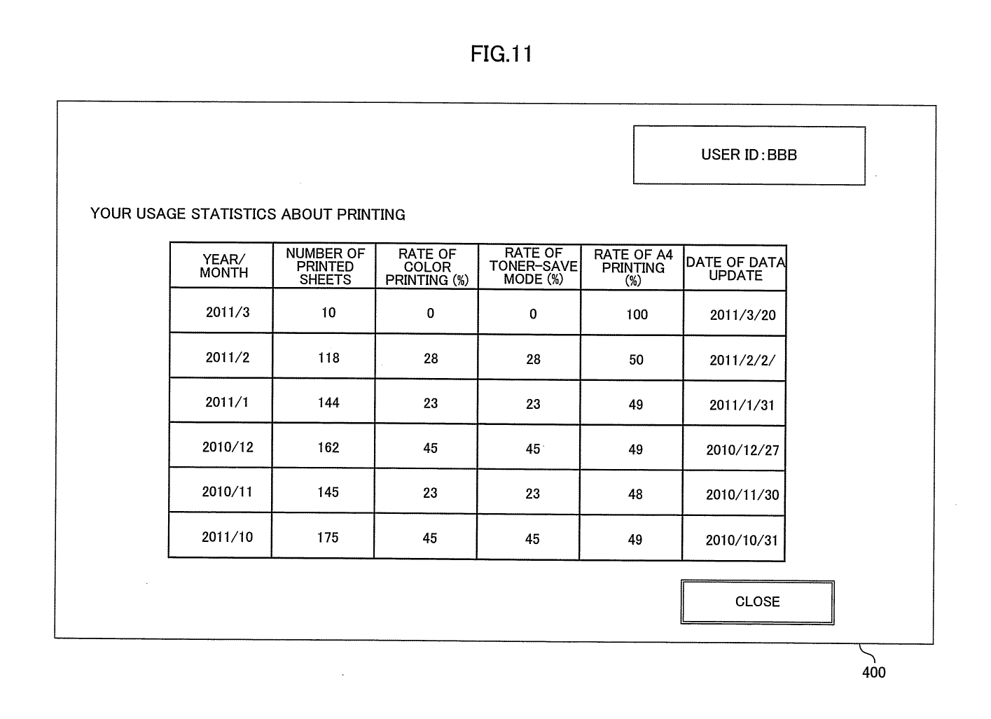

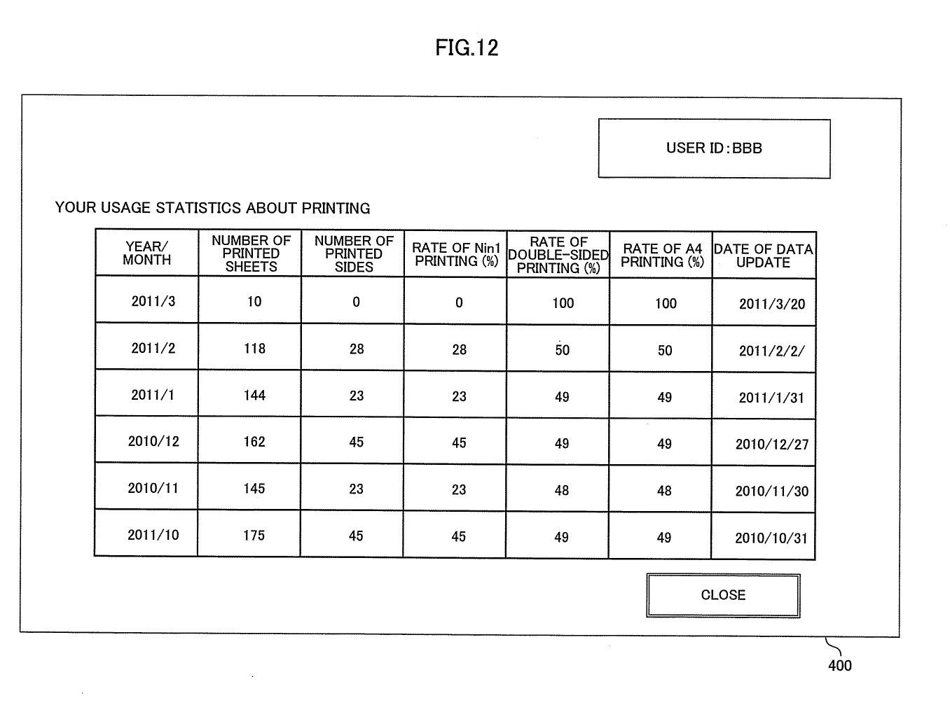

Moreover, in this embodiment, while the information of items shown in FIG. 8 and FIG. 9 are described as the use information output by the use information output section 304, the items of the use information managed and provided by the use information management apparatus 1 is not limited to this. For example, they may be the items shown in FIG. 11 and FIG. 12.

In the case of FIG. 11, items displayed as the use information are the 4 items of: the number of printed sheets, the rate of color printing, the rate of a toner-save mode, and the rate of A4 printing. The number of printed sheets and the number of printed sides are each values of the same items of the tabulation database 188c. The rate of the toner-save mode is a value in which the number of printed sides in the toner-save mode, which are items registered in the tabulation database 188c, is divided by the (total) number of printed sides, and is obtained by:

(the number of toner-save mode printed sides/the number of printed sides×100) (%)

Moreover, the rate of A4 printing is obtained by:

(the number of A4 printed sides/the number of printed sides×100) (%)

In the case of FIG. 12, items displayed as the use information are the 5 items of: the number of printed sheets, the number of printed sides, the rate of Nin1 printing, the rate of double-sided printing, and the rate of A4 printing. The number of printed sheets and the number of printed sides are each values of the same items registered in the tabulation database 188c. The rate of Nin1 printing is the total of the number of sides printed by the Nin1 setting divided by the (total) number of printed sides, and for the tabulation database 188c shown by this embodiment is obtained by:

(the number of 2in1 printed sides+the number of 4in1 printed sides+the number of 6in1 printed sides/the number of printed sides×100) (%)

The rate of double-sided printing is obtained by:

(the number of double-sided printed sides/the number of printed sides×100) (%)

The rate of A4 printing is obtained by:

(The number of A4 printed sides/the number of printed sides×100) (%)

Moreover, in this embodiment, while the use information management apparatus 1 is described as regularly acquiring basic information from the tabulation database 188c of the completed job information collection apparatus 180, and updating the use information database 80, the embodiment is not limited to this. When there is a modification in the contents in the tabulation database 188c, the basic information acquisition section 300 may acquire basic information, and the use information creation section 302 may update the use information database 80.

In this case, for example, the completed job information collection apparatus 180 may further include a modification notifying section that transmits, when the tabulation database 188c is modified, a notification signal informing a modification. Also, on the basis of the notification signal from the modification notifying section, the basic information acquisition section 300 can acquire necessary basic information from the tabulation database 188c, and can register the basic information in the use information database 80, where the use information creation section 302 creates the use information.

Moreover, in the system of this embodiment, while the use information management apparatus 1 is described as an apparatus that creates/manages/provides the use information, it does not need to be an independent apparatus as the use information management apparatus 1. For example, it may be a configuration including a device connected to the network 130, such as the print server 150, provided with a function of the use information management apparatus 1. In this case, the print server 150 manages the print job in the network 130, and also performs a process that manages/provides the use information. In addition, it is not necessary for the completed job information collection apparatus 180 to be an independent apparatus.

In other words, the function which is provided to the use information management apparatus 1 and the function which is provided to the completed job information collection apparatus 180 may be implemented as the entire system, and may be kept any way in the device within the system.

### Second Embodiment

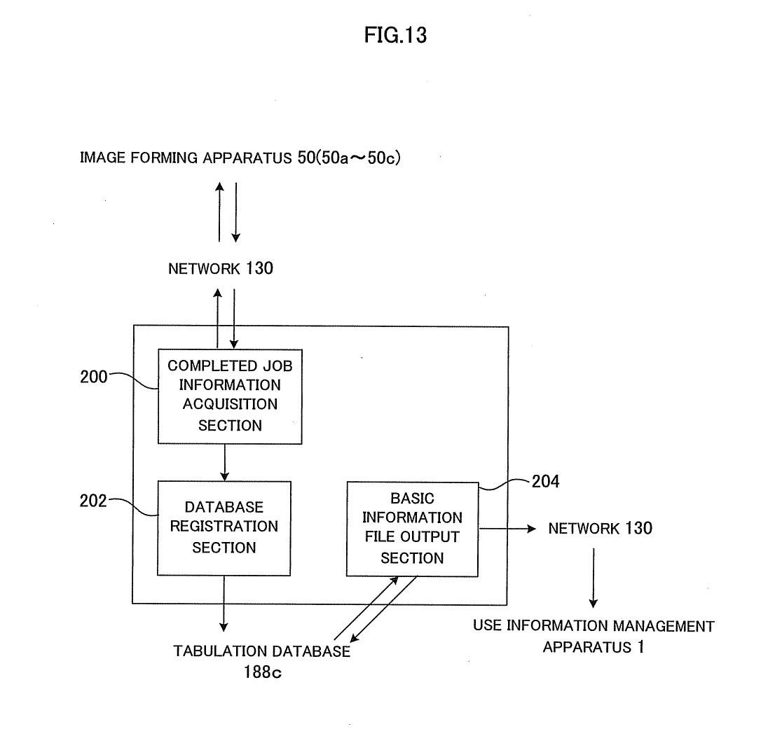

A second embodiment is now described. FIG. 13 is a functional block diagram of the use information management apparatus 1 of this embodiment. The use information management apparatus 1 of this embodiment includes a completed job information acquisition section 200, a database registration control section 202, and a basic information file output section 204. Since the functions of the completed job information acquisition section 200 and the database registration control section 202 are the same as those in the first embodiment, their descriptions are omitted.

The basic information file output section 204 creates a basic information file that compiles necessary basic information, instead of causing the basic information acquisition section 300 of the use information management apparatus 1 to request to the completed job information collection apparatus 180 and to acquire basic information, and outputs this basic information file to the use information management apparatus 1.

The basic information file output section 204 may create and output, in the tabulation database 188c, a basic information file to the use information management apparatus 1, when the data is modified, and may regularly create a basic information file, regardless of any data modification for output.

Moreover, the basic information file may be all of the basic information necessary for creation of use information provided as the use information, and among the basic information, may be only information of the items which have been modified in the tabulation database 188c.

Further, the basic information acquisition section 300 of the use information management apparatus 1 acquires the output basic information file, and the use information creation section 302 creates the use information, on the basis of the basic information included in the acquired basic information file. The subsequent processes are the same as those of the first embodiment.

The providing/managing process of the use information, serving as information that the user wants to confirm, is appropriately performed by any configuration of the embodiments described above.

According to the embodiments as described above, there can be provided an apparatus/system that can provide information in which usage of a user of an image forming apparatus can be easily comprehended by the user, who uses the image forming apparatus connected to a network.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An information management system, comprising:
an information collection section configured to collect completion process information that shows process content of an image forming process completed in an image forming apparatus to be managed, and to register, in a tabulation database, usage information of every user of the image forming apparatus to be managed, on the basis of the collected completion process information;
an item information acquisition section configured to acquire item specification information that specifies information items, serving as types of information of at least one of registration information registered in the tabulation database and information capable of calculation by using the registration information;
a basic information acquisition section configured to acquire, from the tabulation database, basic information necessary for creating use information configured by the information items specified in the item specification information;
an information creation section configured to create, from the basic information acquired by the basic information acquisition section, the use information configured by the information items specified in the item specification information; and
an output section configured to output, to the outside, the use information created by the information creation section.

2. The information management system according to claim 1, further comprising a user information acquisition section configured to acquire user information that identifies a user, and wherein
the basic information acquisition section acquires, from the tabulation database, the basic information corresponding to the user information acquired by the user information acquisition section; and
the information creation section creates use information corresponding to the user information, on the basis of the basic information.

3. The information management system according to claim 1, wherein the item specification information is information that specifies items of the use information for each user.

4. The information management system according to claim 1, wherein the information creation section creates the use information that shows usage of the image forming apparatus to be managed for a prescribed period.

5. The information management system according to claim 1, wherein
the information collection section collects the completion process information from all the image forming apparatuses to be managed by the information management system; and
the use information is information showing the usage of a user in all the image forming apparatuses to be managed.

6. The information management system according to claim 1, further comprising a use information database to which the use information created by the information creation section is registered, and wherein
the information creation section registers, in the use information database, the use information created by the information creation section; and
the output section acquires the use information from the use information database and outputs the use information to a request source if there is a request of the use information from the outside.

7. The information management system according to claim', wherein
the information collection section outputs, if there is a modification in information accumulated in the tabulation database, or regularly, to the basic information acquisition section a basic information file containing the basic information necessary for creating the use information configured by information items specified in the item specification information; and
the information creation section creates the use information by using the basic information contained in the basic information file.

8. An information management method in an information management system including an information collection section that collects completion process information indicating process content of an image forming process completed in an image forming apparatus to be managed, and registers, in a tabulation database, usage information of every user of the image forming apparatus to be managed, on the basis of the collected completion process information, the method comprising:
acquiring item specification information that specifies information items, serving as types of information of at least one of registration information registered in the tabulation database and information capable of calculation by using the registration information;
acquiring, from the tabulation database, basic information necessary for creating use information configured by information items specified in the item specification information;
creating, from the acquired basic information, the use information configured by the information items specified in the item specification information; and
outputting the created use information to the outside.

9. The information management method according to claim 8, comprising:
acquiring user information that identifies a user;
acquiring, from the tabulation database, basic information corresponding to the acquired user information; and
creating the use information corresponding to the user information, on the basis of the acquired basic information.

10. The information management method according to claim 8, wherein the item specification information is information that specifies items of the use information for each user.

11. The information management method according to claim 8, comprising creating the use information indicating usage of the image forming apparatus to be managed for a prescribed period.

12. The information management method according to claim 8, comprising collecting the completion process information from all image forming apparatuses to be managed by the information management system, and wherein
the use information is information indicating usage of a user in all the image forming apparatuses to be managed.

13. The information management method according to claim 8, wherein
the information management system further includes a use information database, to which the created use information is registered;
the created use information is registered in the use information database; and
if there is a request of the use information from the outside, the use information is acquired from the use information database and output to a request source.

14. The information management method according to claim 8, comprising:
outputting, if there is a modification in information accumulated in the tabulation database, or regularly, a basic information file containing the basic information necessary for creating the use information configured by information items specified in the item specification information; and
creating the use information by using the basic information contained in the output basic information file.

15. A computer readable recording medium having recorded thereon a computer program configured to execute, in a computer, an information management process in an information management system including an information collection section that collects completion process information indicating process content of an image forming process completed in an image forming apparatus to be managed, and registers, in a tabulation database, usage information of every user of the image forming apparatus to be managed, on the basis of the collected completion process information; the recording medium executes the processes of:
acquiring item specification information that specifies information items, serving as types of information of at least one of registration information registered in the tabulation database and information capable of calculation by using the registration information;
acquiring, from the tabulation database, basic information necessary for creating use information configured by information items specified in the item specification information;
creating, from the acquired basic information, the use information configured by the information items specified in the item specification information; and
outputting the created use information to the outside.

16. The computer readable recording medium according to claim 15, further configured to execute the processes of:
acquiring user information that identifies a user;
acquiring, from the tabulation database, basic information corresponding to the acquired user information; and
creating the use information corresponding to the user information, on the basis of the acquired basic information.

17. The computer readable recording medium according to claim 15, wherein the item specification information is information that specifies items of the use information for each user.

18. The computer readable recording medium according to claim 15, configured to execute the process of creating the use information indicating usage of the image forming apparatus to be managed for a prescribed period.

19. The computer readable recording medium according to claim 15; configured to execute the process of collecting the completion process information from all image forming apparatuses to be managed by the information management system, and wherein
the use information is information indicating usage of a user in all the image forming apparatuses to be managed.

20. The computer readable recording medium according to claim 15 wherein
the information management system further includes a use information database, to which the created use information is registered;
the created use information is registered in the use information database; and
if there is a request of the use information from the outside, the use information is acquired from the use information database and output to a request source.
